(19) United States
(12) Patent Application Publication
(10) Pub. No.: US 2008/0242287 A1
(43) Pub. Date: Oct. 2, 2008

(54) Method, system and apparatus for cell phone noise reduction

(75) Inventor: James V. Luciani, Acton, MA (US)

Correspondence Address: Ansel M. Schwartz;Attorney at Law, Suite 304, 201 N. Craig Street, Pittsburgh, PA, 15213, US

(73) Assignee: Ericsson, Inc.

(21) Appl. No.: 11/728,846

(22) Filed: Mar. 26, 2007

(51) Int. Cl. H04M 3/00

(52) U.S. Cl. 455/419

(57) ABSTRACT

A telecommunications system includes a cell phone having an audible indication mode which produces an audible signal when a call is received by the phone, a vibration indication mode in which the cell phone vibrates when a call is received and an off mode. The system includes a transmitter remote from the cell phone having a range which produces a wireless change mode signal which causes the phone to change from the audible indication mode to either the vibration indication mode or the off mode. An apparatus for changing cell phones from an audible indication mode which produces an audible signal when a call is received by a phone to a vibrate indication mode in which a cell phone vibrates when a call is received or an off mode. A cell phone. A method for controlling the communication of a cell phone.

### FIELD OF THE INVENTION

The present invention relates to noise reduction of a cell phone in certain situations or locations. More specifically, the present invention relates to noise reduction of a cell phone in certain situations or locations that allows the user to opt to have the user's cell phone respond to a wireless change mode signal that causes the cell phone to change from an audible indication mode to either a vibration indication mode or an off mode.

### BACKGROUND OF THE INVENTION

In many places or situations, social or business (i.e., meetings or in a theater or restaurant), cell phone ringing cadences are considered to be a nuisance, or are merely not permitted. It would be highly desirable to have a mode where the phone is told to not ring or senses that it is in an area where ringing is not acceptable and choice of vibration or off might be selected.

Merely turning off the phone results in potential loss of time, critical calls and putting the phone in vibrate mode has the problem that it is frequently the case that the phone remains in the vibrate setting after the above mentioned situation is over. In this case, again, many times, critical calls may be lost as a result of the vibration being ignored. Some restaurants and theaters actually implement cell phone frequency scramblers which prevent use of cell phones. This has the decided disadvantages of potential loss of emergency communication capability as well as loss of the ability to receive high priority/time critical communication which could be done in socially acceptable methods (e.g., leaving the theater/restaurant and taking the call outside).

### BRIEF SUMMARY OF THE INVENTION

The present invention pertains to a telecommunications system. The system comprises a cell phone having an audible indication mode which produces an audible signal when a call is received by the phone, a vibration indication mode in which the cell phone vibrates when a call is received and an off mode. The system comprises a transmitter remote from the cell phone having a range which produces a wireless change mode signal which causes the phone to change from the audible indication mode to either the vibration indication mode or the off mode.

The present invention pertains to an apparatus for changing cell phones from an audible indication mode which produces an audible signal when a call is received by a phone to a vibrate indication mode in which a cell phone vibrates when a call is received or an off mode. The apparatus comprises a transmitter having a range which broadcasts a change mode signal to the cell phones in the range to cause the cell phones to change from the audible indication mode to either the vibration indication mode or the off mode. The apparatus comprises a power source in electrical communication with the transmitter.

The present invention pertains to a cell phone having an audible indication mode which produces an audible signal when a call is received by the phone, a vibration indication mode in which the cell phone vibrates when a call is received and an off mode. The audible indication mode changes to either the vibration indication mode or the off mode when the cell phone receives a wireless change mode signal.

The present invention pertains to a method for controlling the communication of a cell phone. The method comprises the steps of receiving a change mode signal at the cell phone. There is the step of changing the cell phone from an audible indication mode which produces an audible signal when a call is received by the phone to either a vibration indication mode in which the cell phone vibrates when a call is received or an off mode.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a block diagram of the system of the present invention.

FIG. 2 is a schematic representation of the system of the present invention.

### DETAILED DESCRIPTION OF THE INVENTION

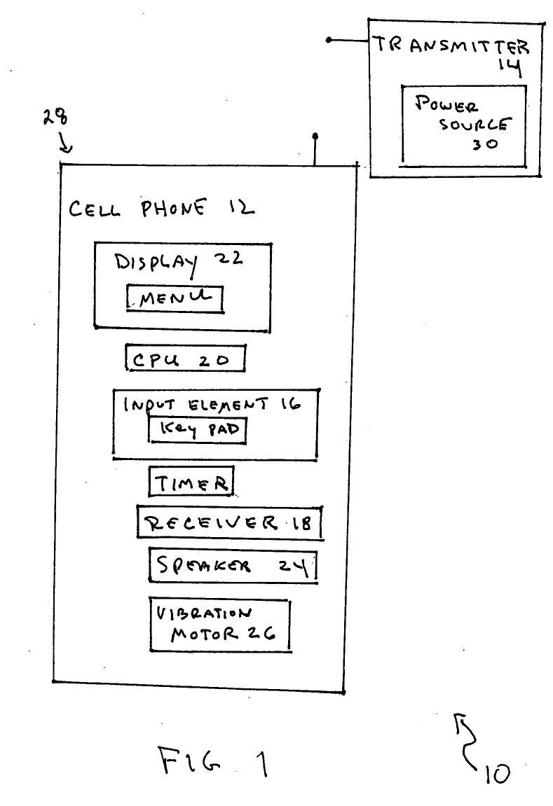

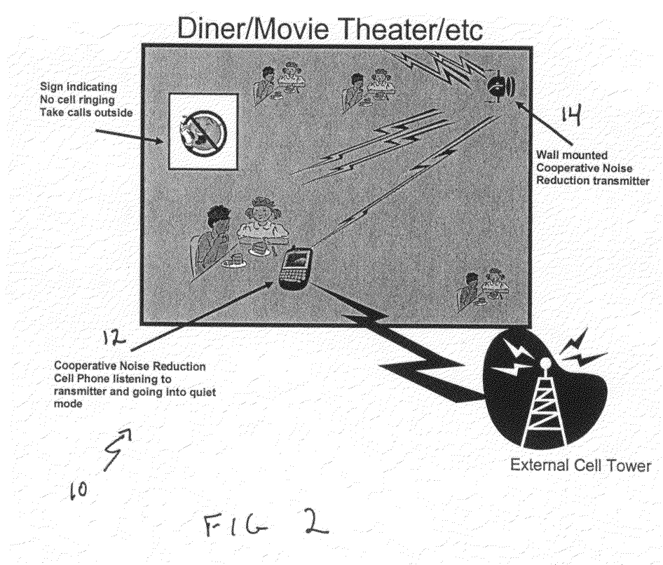

Referring now to the drawings wherein like reference numerals refer to similar or identical parts throughout the several views, and more specifically to FIGS. 1 and 2 thereof, there is shown a telecommunications system 10. The system 10 comprises a cell phone 12 having an audible indication mode which produces an audible signal when a call is received by the phone 12, a vibration indication mode in which the cell phone 12 vibrates when a call is received and an off mode. The system 10 comprises a transmitter 14 remote from the cell phone 12 having a range which produces a wireless change mode signal which causes the phone 12 to change from the audible indication mode to either the vibration indication mode or the off mode.

Preferably, the cell phone 12 returns to the audible indication mode from the vibration indication mode when the cell phone 12 is outside the range. The cell phone 12 preferably returns to the audible indication mode from the vibration indication mode after a predetermined time has passed from when the phone 12 has last received the change mode signal. Preferably, the cell phone 12 has an input element 16 through which the user elects to have the phone 12 respond to the change mode signal.

The user preferably elects through the input element 16 for the phone 12 to respond to the change mode signal by either changing from the audible indication mode to the vibration indication mode or from the audible indication mode to the off mode. Preferably, the phone 12 has a receiver 18 to receive the change indication signal. The phone 12 preferably has a CPU 20 which changes the mode when the change indication signal is received. Preferably, the phone 12 has a visual display 22.

The CPU 20 preferably causes a menu to appear on the display 22 from which a user can elect with the input device for the phone 12 to change from the audible indication mode to either a vibration indication mode or the off mode. Preferably, the cell phone 12 receives calls at a first frequency and receives the change indication signal at a second frequency distinct and separate from the first frequency. The transmitter 14 preferably transmits the change indication signal at the second frequency.

Preferably, the transmitter 14 transmits the change indication signal over time. The phone 12 preferably includes a speaker 24 which plays the audible indication signal. Preferably, the phone 12 includes a vibration motor 26 which causes the phone 12 to vibrate. Alternatively, the cell phone 12 receives calls at a first frequency and receives the change indication signal at the first frequency.

The present invention pertains to an apparatus 28 for changing cell phones 12 from an audible indication mode which produces an audible signal when a call is received by a phone 12 to a vibrate indication mode in which a cell phone 12 vibrates when a call is received or an off mode. The apparatus 28 comprises a transmitter 14 having a range which broadcasts a change mode signal to the cell phones 12 in the range to cause the cell phones 12 to change from the audible indication mode to either the vibration indication mode or the off mode. The apparatus 28 comprises a power source 30 in electrical communication with the transmitter 14.

The present invention pertains to a cell phone 12 having an audible indication mode which produces an audible signal when a call is received by the phone 12, a vibration indication mode in which the cell phone 12 vibrates when a call is received and an off mode. The audible indication mode changes to either the vibration indication mode or the off mode when the cell phone 12 receives a wireless change mode signal.

The present invention pertains to a method for controlling the communication of a cell phone 12. The method comprises the steps of receiving a change mode signal at the cell phone 12. There is the step of changing the cell phone 12 from an audible indication mode which produces an audible signal when a call is received by the phone 12 to either a vibration indication mode in which the cell phone 12 vibrates when a call is received or an off mode.

Preferably, there is the step of electing for the phone 12 to respond to the change mode signal by cooperatively either changing from the audible indication mode to the vibration indication mode or from the audible indication mode to the off mode. There is preferably the step of returning the phone 12 to the audible indication mode from the vibration indication mode.

In the operation of the invention, a situation/position sensitive mechanism directs a cell phone 12 to go into either vibrate mode or to turn off based on user configuration when in such situations/positions. Further, it is desired for both security and potential emergency reasons, that a given user is not forced to participate but may opt in to use this “service”.

The system 10 is embodied in two parts: 1) a cell phone 12 capable of participating in the opt in mode either in the form of changing from ringing to vibrate mode or ringing to off mode when in the given situation/location, and 2) a location restricted/bounded mechanism to communicate to the phone 12 that it is not acceptable to offer ringing cadence to the user. The first part may, but is not limited to, be instantiated through the creation of a user configurable setting for a cell phone 12, where the cell phone 12 receives a “signal” from a location restricted/bounded mechanism to tell it to behave in the appropriate way. The second part may be instantiated by a number of mechanisms. One example of such a mechanism is a transmitter 14 which sends the “signal” to the cell phone 12 to behave in the opted in fashion. This may be a transmitter 14 on a completely different frequency than that of the cellular service. One alternative might be for the transmitter 14 to be itself a base station which is transmitting a broadcast message to all receivers 18 within its location restricted area to behave appropriately. Once having received such a signal, the cell phone 12 will remain in the appropriate mode for a given length of time or until it receives another such message after which the cell phone 12 will remain in the opted in mode for another period of time, etc.

This invention does not suffer from the drawbacks described above, and accomplishes the task, but in an opt in way which will be much more amenable an approach to solving the problem than forcible methods require: e.g., cell phone 12 spectra scramblers, etc.

In a preferred embodiment, a cell phone 12 user though its input element 16, such as a typical keypad, elects with the menu on the phone's 12 display 22 the opt in mode for the phone 12 to respond to a wireless change mode signal. The CPU 20 of the phone 12 then implements this election and places the phone 12 into the opt in mode. When the user with the phone 12 activated comes within range of a transmitter 14 transmitting a change mode signal, the receiver 18 of the cell phone 12 receives the change mode signal. The transmitter 14 can have a range of 25 to 75 yards in radius, for example.

The CPU 20 processes the change mode signal and changes the phone 12 from the audible mode, where the speaker 24 of the phone 12 produces an audible signal when a call is received by the phone 12, to either a vibration indication mode in which the cell phone 12 vibrates when a call is received or an off mode, depending on how the user elected for the phone 12 to respond to the change node signal. When an incoming call is received by the phone 12, and assuming the phone 12 is now in the vibration indication mode, the vibrate motor 26 of the phone 12 activates to indicate the presence of the call for the user. The range of the transmitter 14 covers the location desired to be protected. Locations can include any place where protection against audible signals are desired at least for some period of time. Some examples, but not limited thereto, are restaurants, theaters, classrooms, and auditoriums.

The transmitter 14 can be mounted at any appropriate position that places the range of its signal over the location to be protected. If necessary, there can be a plurality of transmitters 14 to cover the desired location. The transmitter 14 can be mounted on a wall, or a floor or a ceiling or a roof or on a support such as a pole. The phone 12 receives calls at a first frequency and the transmitter 14 transmits the change mode signal at second frequency different from the first frequency. Generally, all phones 12 in the opt in mode within the range of the transmitter 14 or transmitters 14 receive the change mode signal at the second frequency different from each cell phone's 12 primary receive call frequency so the transmitter 14 can effectively broadcast the change mode signal to all the phones 12 within the range.

The phone 12 converts back to the audible indication mode, if it was originally in the audible indication mode when it entered the range, when it leaves the range. Alternatively, the phone 12 can remain in the vibrate only mode for a predetermined period of time, for instance 2 minutes, of the last time the phone 12 receives the vibrate only signal from the transmitter 14. A timer in the phone 12 releases the phone 12 from the vibrate only mode after the predetermined period of time.

When the same frequency is used to transmit the change signal as the call, the transmitter 14 is a base station modified for cooperative mode transmission. In this way, it operates like all base stations do, but it also has the ability to tell the phone 12 to go to vibrate mode or turn off to off mode. It basically is the functional equivalent of an SMS directed at the phone rather than a user.

Different frequencies are used to transmit the change signal and a call. The transmitter 14 is merely a transmitter. The frequency would be fixed by design (that is, the phone provider is told a priori what frequency to listen to and this is actually part of the system). In either case, the transmission of the change mode signal can be continuous or at a given interval which will allow for the vibrate mode to “not time out” and thus return to normal operation.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A telecommunications system comprising:
a cell phone having an audible indication mode which produces an audible signal when a call is received by the phone, a vibration indication mode in which the cell phone vibrates when a call is received and an off mode; and
a transmitter remote from the cell phone having a range which produces a wireless change mode signal which causes the phone to change from the audible indication mode to either the vibration indication mode or the off mode.

2. A system as described in claim 1 wherein the cell phone returns to the audible indication mode from the vibration indication mode when the cell phone is outside the range.

3. A system as described in claim 1 wherein the cell phone returns to the audible indication mode from the vibration indication mode after a predetermined time has passed from when the phone has last received the change mode signal.

4. A system as described in claim 2 wherein the cell phone has an input element through which the user elects to have the phone respond to the change mode signal.

5. A system as described in claim 4 wherein the user elects through the input element for the phone to respond to the change mode signal by either changing from the audible indication mode to the vibration indication mode or from the audible indication mode to the off mode.

6. A system as described in claim 5 wherein the phone has a receiver to receive the change indication signal.

7. A system as described in claim 6 wherein the phone has a CPU which changes the mode when the change indication signal is received.

8. A system as described in claim 7 wherein the phone has a visual display.

9. A system as described in claim 8 wherein the CPU causes a menu to appear on the display from which a user can elect with the input device for the phone to change from the audible indication mode to either a vibration indication mode or the off mode.

10. A system as described in claim 9 wherein the cell phone receives calls at a first frequency and receives the change indication signal at a second frequency distinct and separate from the first frequency.

11. A system as described in claim 10 wherein the transmitter transmits the change indication signal at the second frequency.

12. A system as described in claim 11 wherein the transmitter transmits the change indication signal over time.

13. A system as described in claim 12 wherein the phone includes a speaker which plays the audible indication signal.

14. A system as described in claim 13 wherein the phone includes a vibration motor which causes the phone to vibrate.

15. A system as described in claim 9 wherein the cell phone receives calls at a first frequency and receives the change indication signal at the first frequency.

16. An apparatus for changing cell phones from an audible indication mode which produces an audible signal when a call is received by a phone to a vibrate indication mode in which a cell phone vibrates when a call is received or an off mode comprising:
a transmitter having a range which broadcasts a change mode signal to the cell phones in the range to cause the cell phones to change from the audible indication mode to either the vibration indication mode or the off mode; and
a power source in electrical communication with the transmitter.

17. A cell phone having an audible indication mode which produces an audible signal when a call is received by the phone, a vibration indication mode in which the cell phone vibrates when a call is received and an off mode, the audible indication mode changing to either the vibration indication mode or the off mode when the cell phone receives a wireless change mode signal.

18. A method for controlling the communication of a cell phone comprising the steps of:
receiving a change mode signal at the cell phone; and
changing the cell phone from an audible indication mode which produces an audible signal when a call is received by the phone to either a vibration indication mode in which the cell phone vibrates when a call is received or an off mode.

19. A method as described in claim 18 including the step of electing for the phone to respond to the change mode signal by cooperatively either changing from the audible indication mode to the vibration indication mode or from the audible indication mode to the off mode.

20. A method as described in claim 19 including the step of returning the phone to the audible indication mode from the vibration indication mode.
